(19) United States
(12) Patent Application Publication
(10) Pub. No.: US 2025/0308093 A1
(43) Pub. Date: Oct. 2, 2025

(54) MAP GENERATION DEVICE, MAP GENERATION SYSTEM, MAP GENERATION METHOD, AND STORAGE MEDIUM

(71) Applicant: HONDA MOTOR CO., LTD., TOKYO (JP)

(72) Inventors: Taiki YAMADA, TOKYO (JP); Kazuhide TAKAGI, TOKYO (JP); Daijiro MIYAMOTO, TOKYO (JP); Ryusuke TAMANAHA, TOKYO (JP)

(21) Appl. No.: 19/065,778

(22) Filed: Feb. 27, 2025

(30) Foreign Application Priority Data
Mar. 28, 2024 (JP) 2024-052943

(51) Int. Cl. G06T 11/00; G06T 11/60

(52) U.S. Cl. CPC G06T 11/001; G06T 11/60

(57) ABSTRACT

A map generation device includes an acquisition unit configured to acquire music information about a music piece played by a music playback device and location information indicating a location where the music piece is played by the music playback device, and a generation unit configured to generate a music playback map based on the music information and the location information acquired by the acquisition unit.

### CROSS-REFERENCE TO RELATED APPLICATIONS

This application is based upon and claims the benefit of priority from Japanese Patent Application No. 2024-052943 filed on Mar. 28, 2024, the contents of which are incorporated herein by reference.

### BACKGROUND OF THE INVENTION

### Field of the Invention

The present disclosure relates to a map generation device, a map generation system, a map generation method, and a Storage Medium.

### Description of the Related Art

JP 2012-018719 A discloses a vehicle-mounted music playback device that creates a playlist of music pieces corresponding to the current location of a vehicle and playbacks the pieces of music.

### SUMMARY OF THE INVENTION

There is a long felt need for techniques that can better provide information about music pieces.

The present invention aims to solve the above-mentioned problems.

A first aspect of the present disclosure is a map generation device including an acquisition unit that acquires music information about a music piece played by a music playback device and location information indicating a location where the music piece was played by the music playback device, and a generation unit configured to generate a music playback map based on the music information and the location information acquired by the acquisition unit.

A second aspect of the present disclosure is a map generation system including a map generation device and a map display device, and comprising an acquisition unit configured to acquire music information about a music piece played by a music playback device and location information indicating a location where the music piece is played by the music playback device, a generation unit configured to generate a music playback map based on the music information and the location information acquired by the acquisition unit, and a display unit configured to display the music playback map generated by the generation unit.

A third aspect of the present disclosure is a map generation method including an acquisition step of acquiring music information about a music piece played by a music playback device and location information indicating a location where the music piece is played by the music playback device, and a generation step of generating a music playback map based on the music information and the location information acquired in the acquisition step.

A fourth aspect of the present disclosure is a program for causing a computer to execute the map generation method according to the third aspect.

According to the present invention, information about music can be provided in a better manner.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram illustrating a map generation system;

FIGS. 2A and 2B are diagrams showing display examples of a music playback map;

FIG. 3 is a flowchart showing an operation example of a map generation device;

FIG. 4 is a diagram showing a display example of the music playback map;

FIG. 5 is a diagram showing a display example of the music playback map;

FIG. 6 is a block diagram showing an example of the configuration of the map generation device;

FIG. 7 is a diagram showing a display example in which activity schedule information indicating an activity schedule of a musician is superimposed on the music playback map;

FIG. 8 is a flowchart showing an operation example of the map generation device;

FIG. 9 is a diagram showing a display example where ranking information and trend information of music pieces are added to a music playback map; and

FIG. 10 is a diagram illustrating a map generation system.

### DETAILED DESCRIPTION OF THE INVENTION

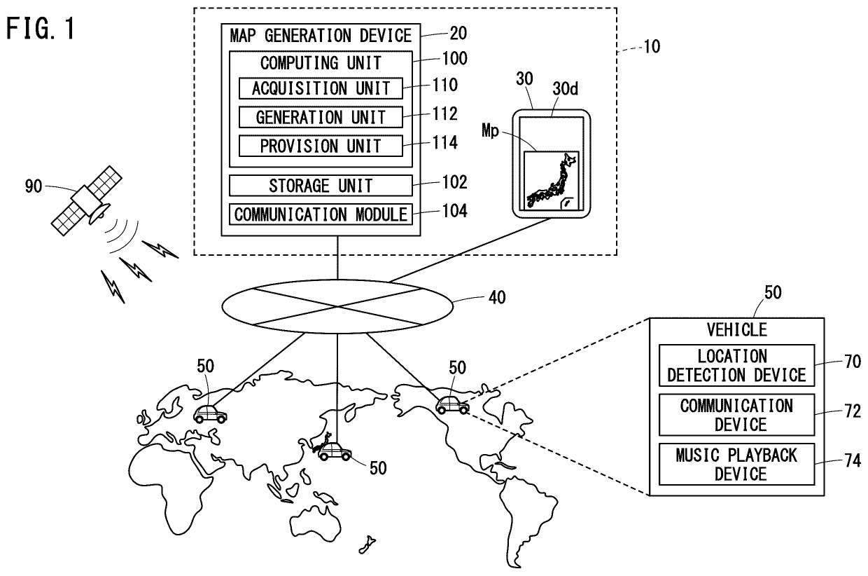

A map generation system including a map generation device and a map display device according to an embodiment will be described with reference to the drawings. FIG. 1 is a diagram illustrating a map generation system 10. A map generation system 10 has a map generation device 20 and a map display device 30.

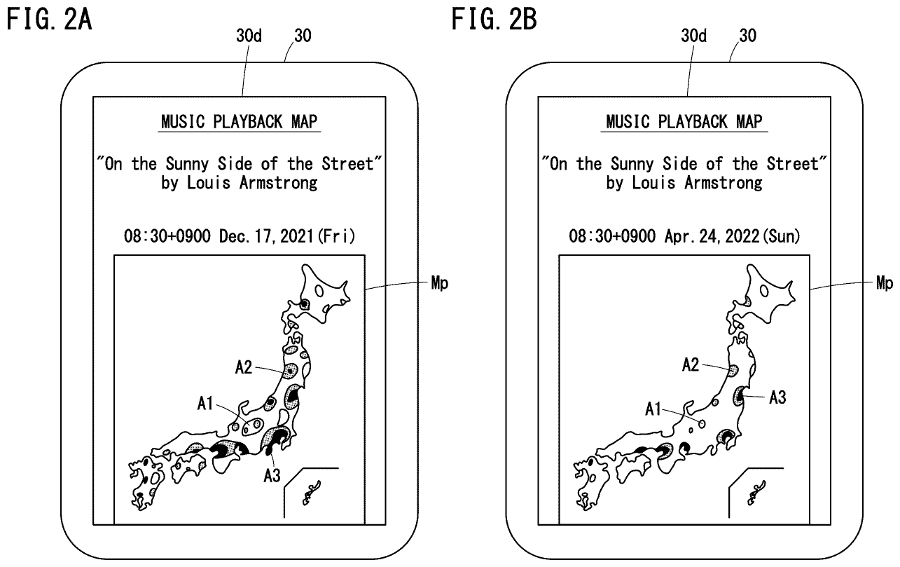

The map generation device 20 generates a music playback map Mp indicating which music piece is currently played at which location. The configuration of the map generation device 20 will be described later. The details of the music playback map Mp will be described later with reference to FIGS. 2A and 2B, and so on. The map display device 30 has a communication module (not shown) and a display unit 30d. The map display device 30 is, for example, a smartphone, a tablet computer, a personal computer, or the like. Both the map generation device 20 and the map display device 30 are connected to a communication network 40.

The map display device 30 displays on the display unit 30d the music playback map Mp provided from the map generation device 20 via the communication network 40. As a result, people involved in the music industry can see the music playback map Mp. A general user may view the music playback map Mp.

A vehicle 50 is equipped with a location detection device 70, a communication device 72, and a music playback device 74. FIG. 1 illustrates a state in which a plurality of vehicles 50 are moving at various locations. The location detection device 70 detects the location and the current time of the vehicle 50 based on a positioning signal from a positioning satellite 90.

By means of the communication device 72, the vehicle 50 is also connected to the communication network 40. The communication device 72 may be a portable terminal brought into the vehicle 50. The music playback device 74 plays back music pieces. A music piece to be played by the music playback device 74 may be selected from the music pieces stored in the music playback device 74. The music piece to be played by the music playback device 74 may be selected from the music pieces that can be distributed from a music distribution server via the communication network 40 and the communication device 72. The music piece to be played by the music playback device 74 may be selected from the music pieces stored in the portable terminal in the vehicle 50.

The music information about the music piece played by the music playback device 74 is supplied to the map generation device 20 by the music playback device 74 via the communication device 72 together with the location information indicating the location where the music piece is played by the music playback device 74. Furthermore, the time information indicating the time at which the music piece is played by the music piece playback device 74 is supplied to the map generation device 20 by the music piece playback device 74 via the communication device 72. The music information includes, for example, information about the title of the music piece and information about musicians of the music piece.

When a music piece contains lyrics, the musicians of the music piece are, for example, the singer, the lyricist, the performer, the composer, and so on of the music piece. When a music piece does not contain lyrics, the musicians of the music piece is, for example, the performer, composer, and so on of the music piece. The musicians of a musical piece may be, for example, the producer of the musical piece.

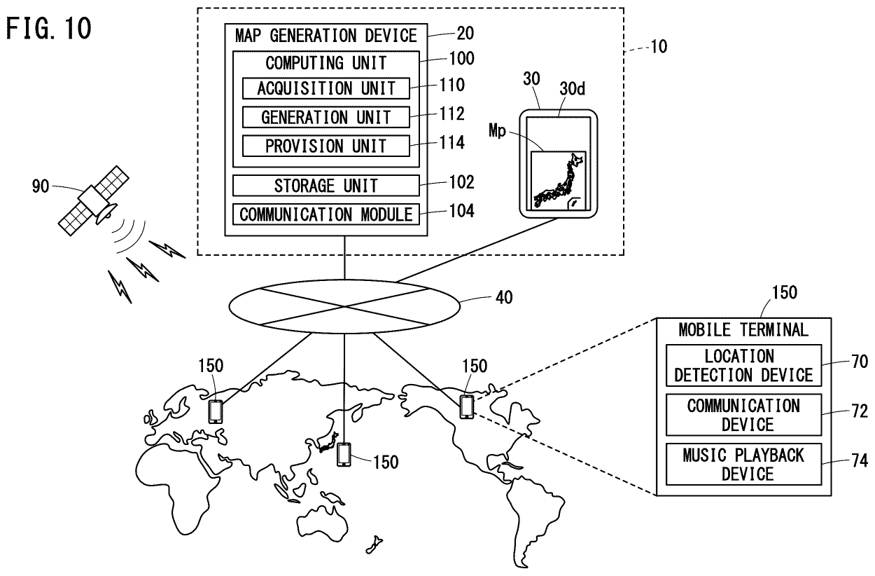

It is preferable that the music playback device 74 is provided on a movable body rather than a fixed object such as a building and is movable. In the present embodiment, the music playback device 74 is provided in the vehicle 50, but the music playback device 74 may be mounted on another movable body or may be constituted by another movable body. An example in which the music playback device 74 is formed by a portable terminal will be described later with reference to FIG. 10.

The map generation device 20 includes a computing unit 100, a storage unit 102, and a communication module 104. The computing unit 100 is a computer and includes a processor such as a CPU (Central Processing Unit) or a GPU (Graphics Processing Unit). That is, the computing unit 100 includes processing circuitry.

The storage unit 102 is a computer-readable storage medium. The storage unit 102 includes volatile memory such as a RAM (Random Access Memory) and non-volatile memory such as a ROM (Read Only Memory) or a flash memory. The volatile memory is used as working memory for a processor. The non-volatile memory stores programs, map data, or the like executed by the processor. That is, the map generation device 20 has a program product of a program executed by the processor.

The programs stored in the storage unit 102 are executed, whereby the music playback map Mp is generated based on the above-described music information and location information.

The communication module 104 is used for communication between the map generation device 20 and the map display device 30 via the communication network 40. The communication module 104 is also used for communication between the map generation device 20 and the vehicle 50 via the communication network 40.

The computing unit 100 includes an acquisition unit 110, a generation unit 112, and a provision unit 114. The acquisition unit 110, the generation unit 112, and the provision unit 114 are realized by the computing unit 100 executing the programs stored in the storage unit 102. At least part of the acquisition unit 110, the generation unit 112, and the provision unit 114 may be realized by an integrated circuit such as an ASIC (Application Specific Integrated Circuit) or an FPGA (Field Programmable Gate Array), or an electronic circuit including discrete devices.

The acquisition unit 110 acquires the music information, the location information, and the time information described above via the communication network 40 and the communication module 104.

The generating unit 112 generates the music playback map Mp based on the music information and the location information acquired by the acquisition unit 110. When music information about a plurality of pieces of music is acquired, the generation unit 112 generates a music playback map Mp for each piece of music corresponding to each of the plurality of pieces of music. The generating unit 112 generates the music playback map Mp for each time instant based on the time information acquired by the acquisition unit 110.

The providing unit 114 provides the music playback map Mp generated by the generating unit 112 to the map display device 30 via the communication module 104 and the communication network 40.

The music playback map Mp is generated for each music piece and for each time instant by the generating unit 112 based on the music information, the location information, and the time information acquired by the acquisition unit 110. Therefore, the number of times a specific music piece is played (a play count of a specific music piece) at a specific time can be known. In addition, by comparing play counts of the same music piece in the same region at different time instants, it is possible to grasp the temporal change in the play count.

FIGS. 2A and 2B are diagrams showing display examples of the music playback map MP. The music playback map Mp indicates at which location in a specific region a specific music is played at a specific time. The music playback maps Mp illustrated in FIGS. 2A and 2B correspond to the same region and the same music piece and also correspond to different time instants. The region is Japan. The music piece is “On the Sunny Side of the Street” and the musician of the music piece is Louis Armstrong.

FIG. 2A shows a music playback map Mp corresponding to the location where the music piece is being played at 8:30 local time on Dec. 17, 2021 by the music playback device 74 provided in the vehicle 50. The music playback map Mp is displayed on the display unit 30d of the map display device 30.

When the location where the music piece is being played is displayed, it is possible that the music play map Mp will be difficult to see due to the crowding of the locations. Therefore, the music playback map Mp shown in FIG. 2A is colored (color coded) according to the density of the locations where the music piece is being played. As a result, it becomes easier to see the music playback map Mp. The density of the locations where the music piece is being played corresponds to the number of times the music piece is played. That is, the music playback map Mp is colored according to the number of times the music piece is played.

In the example shown in FIG. 2A, an area A1 in the music playback map Mp is displayed in green. This indicates that the music piece is being played in the area A1. An area A2 in the music playback map Mp is displayed in yellow. This indicates that a play count of the music piece in the area A2 is larger than a play count of the music piece in the area A1. An area A3 in the music playback map Mp is displayed in red. This indicates that a play count of the music piece in the area A3 is larger than the play count of the music piece in the area A2.

Areas that are neither the area A1, the area A2, nor the area A3 in the music playback map Mp are not colored. A play count of the music piece in the uncolored area is even less than the play count of the music piece in the area A1 or is zero.

FIG. 2B shows a music playback map Mp corresponding to the location where the music piece is being played at 8:30 local time on Apr. 24, 2022 by the music playback device 74 provided in the vehicle 50. That is, the time instant corresponding to the music playback map Mp shown in FIG. 2B is later than the time instant corresponding to the music playback map Mp shown in FIG. 2A. The music playback map Mp is displayed on the display unit 30d of the map display device 30.

As in FIG. 2A, the music playback map Mp shown in FIG. 2B is colored according to the number of times the music piece is played. The music playback map Mp shown in FIG. 2B indicates that the play count of the music piece has reduced compared to the music playback map Mp shown in FIG. 2A. A play count of a music piece corresponds to the popularity of the music piece. Therefore, it is understood that the time has passed and the play count of the music piece has decreased, resulting in that the popularity of the music piece has lowered.

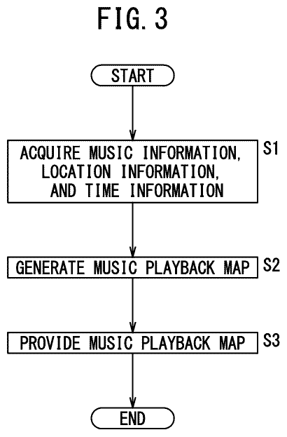

FIG. 3 is a flowchart showing an operation example of the map generation device 20. FIG. 3 shows the processing procedure of a map generation method by the map generation device 20. The processing procedure is performed by the computing unit 100 of the map generation device 20 executing the program stored in the storage unit 102.

When the processing procedure is started, in step S1, the acquisition unit 110 acquires music information, location information, and time information through communication. In step S2, the generating unit 112 generates the music playback map Mp for each music piece and for each time instant based on the music piece information, the location information, and the time information acquired in step S1. In step S3, the providing unit 114 provides the music playback map Mp generated in step $2 to the map display device 30 through communication. When the process of step S3 is completed, the present processing procedure ends.

In this embodiment, the map generation device 20 acquires music information and location information regarding the music piece played by the music playback device 74 provided in the vehicle 50. The map generation device 20 generates a music playback map Mp based on the acquired music information and location information. Therefore, it is possible to grasp which music piece is being played in the vehicle 50 at which location.

The above-described embodiment may be modified as follows. In the following modified examples, the redundant explanations overlapping with the above-described embodiment will be omitted.

### Modified Example 1

In the above-described embodiment, the music playback map Mp is generated for each music piece but the present disclosure is not limited to this. In modified example 1, the music information acquired from the music playback device 74 by the acquisition unit 110 further includes information indicating the genres of the music pieces. The generating unit 112 generates a music playback map Mp for each genre.

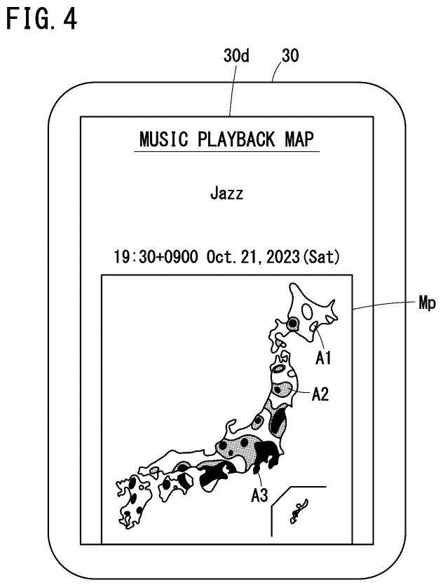

FIG. 4 is a diagram showing a display example of the music playback map Mp. The music playback map Mp is displayed on the display unit 30d of the map display device 30. The music playback map Mp represents at which location in a specific region music pieces of a specific genre are being played at a specific time. FIG. 4 shows the locations where jazz tracks are being played in Japan at 19:30 local time on Oct. 21, 2023. As illustrated in FIG. 4, a music playback map Mp colored in the same manner as FIGS. 2A and 2B is displayed. It is possible to identify which genres of music pieces are being played at which location.

### Modified Example 2

In modified example 2,the music information acquired from the music playback device 74 by the acquisition unit 110 further includes information indicating keywords included in the lyrics or the title of the music piece. The generating unit 112 generates a music playback map Mp according to the keywords. Note that the music information may include all information of the lyrics or the title of the music piece. In this case, the generation unit 112 determines keywords based on the acquired music information.

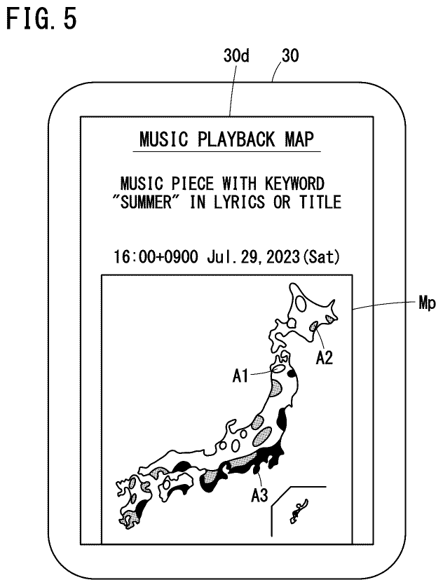

FIG. 5 is a diagram showing a display example of the music playback map Mp. The music playback map Mp is displayed on the display unit 30d of the map display device 30. The music playback map Mp represents at which location in a specific region music pieces of a specific genre are being played at a specific time. FIG. 5 shows the locations where a music piece with a keyword “summer” in the lyrics or title is being played in Japan at 16:00 local time on Jul. 29, 2023. As illustrated in FIG. 5, a music playback map Mp colored in the same manner as in FIGS. 2A and 2B is displayed. It is possible to know the play count of the music piece related to a specific keyword at a specific time in a specific region.

### Modified Example 3

In the above-described embodiment, the music playback map Mp is displayed on the display unit 30d of the map display device 30 but the present disclosure is not limited to this. In modified example 3, the music information acquired from the music playback device 74 by the acquisition unit 110 further includes information indicating the genres of the music pieces.

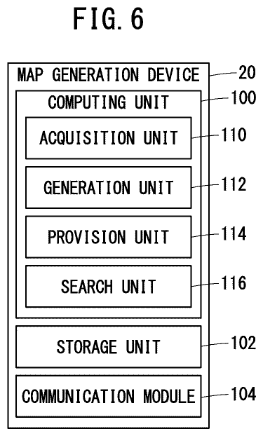

FIG. 6 is a block diagram showing an example of the configuration of the map generation device 20. The computing unit 100 further includes a search unit 116. The search unit 116 searches for activity schedule information related to an activity schedule of a musician of a music piece indicated by music information or an activity schedule of a musician related to a genre of the music piece via the communication module 104 and the communication network 40 based on the music information, the location information, and the time information acquired by the acquisition unit 110.

The activity schedule of a musician is composed of a venue and a date and time of an event in which the musician is to perform. The generating unit 112 superimposes the activity schedule information retrieved by the search unit 116 on the generated music playback map Mp. Since the activity schedule information is superimposed on the music playback map Mp, the convenience of the music playback map Mp is enhanced.

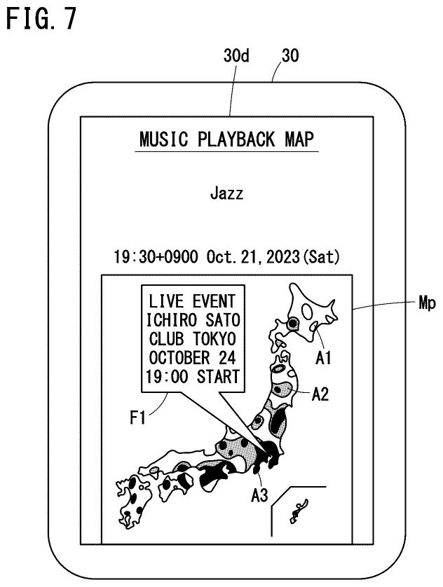

FIG. 7 is a diagram showing a display example in which activity schedule information F1 indicating an activity schedule of a musician is superimposed on the music playback map Mp. The music playback map Mp indicating at which location in a specific region music pieces of a specific genre are being played at a specific time is displayed on the display unit 30d of the map display device 30, as in FIG. 4. Furthermore, the activity schedule information F1 about the activity schedule of the musician related to the genre is displayed in superposition on the music playback map Mp.

In the example shown in FIG. 7, the activity schedule F1 indicating that a live event of a jazz singer “Ichiro Sato” is scheduled to start at 19:00 on Oct. 24, 2023 in Club Tokyo is displayed in superposition on the music playback map Mp indicating locations where jazz tracks are being played at 19:30 local time on Oct. 21, 2023.

In the example shown in FIG. 7, the activity schedule information F1 of the musician related to the genre of the music piece indicated by the acquired music information is displayed on the display unit 30d of the map display device 30 but the present disclosure is not limited to this. The activity schedule information F1 about the activity schedule of the musician of the music piece indicated by the acquired music information may be displayed.

The search unit 116 searches for the activity schedule information F1 concerning an activity schedule within a predetermined period from a time instant corresponding to the music playback map Mp. The predetermined period is set to, for example, about one week to one month, whereby the activity schedule information F1 concerning activity schedules in a relatively near future can be retrieved. In the example shown in FIG. 7, information about a live event starting at 19:00 on Oct. 24, 2023, which falls within one week from 19:30 on Oct. 21, 2023 corresponding to the music playback map Mp, is, as activity schedule information F1, superimposed on the music playback map Mp.

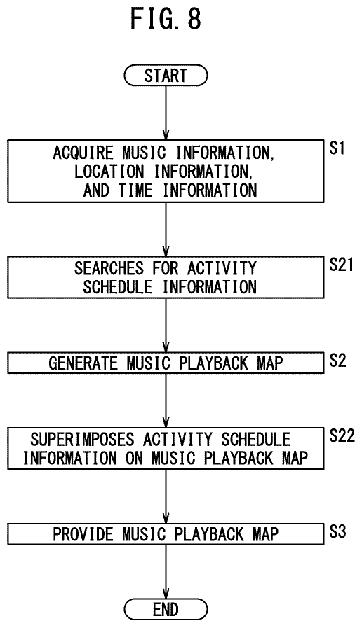

FIG. 8 is a flowchart showing an operation example of the map generation device 20. FIG. 8 shows the processing procedure of a map generation method by the map generation device 20. The processing procedure is performed by the computing unit 100 of the map generation device 20 executing the program stored in the storage unit 102. Steps similar to those described above with reference to FIG. 3 are denoted by the same reference numerals and descriptions are omitted as appropriate.

When the process of step S1 is completed, the processing procedure proceeds to step S21. In step S21, the search unit 116 searches for the activity schedule information F1 regarding the activity schedule of the musician of the music piece or the activity schedule of the musician related to the genre of the music piece through communication based on the music information, the location information, and the time information acquired in step S1. When the process of step S21 is completed, the processing procedure proceeds to step S2.

When the process of step S2 is completed, the processing procedure proceeds to step S22. In step S22, the generating unit 112 superimposes the activity schedule information F1 retrieved in step S21 on the music playback map Mp. When the process of step S22 is completed, the processing procedure proceeds to step S3, where a music playback map Mp on which the activity schedule information F1 has been superimposed is provided. When the process of step S3 is completed, the present processing procedure ends.

### Modified Example 4

In modified example 4, the search unit 116 shown in FIG. 6 further searches for ranking information indicating the ranking of play counts of music pieces. The search unit 116 stores the searched ranking information in the storage unit 102 in association with the time information acquired by the acquisition unit 110. The generation unit 112 adds the ranking information retrieved by the search unit 116 to the generated music playback map Mp. Since the ranking information of the music pieces is added to the music playback map Mp, the popularity of the music pieces can be more clearly grasped.

The generation unit 112 further generates, based on the ranking information stored in the storage unit 102, trend information regarding the fluctuation in the ranking of the play counts of the music pieces. The trend information indicates that the ranking of a music piece is in an ascending or descending trend, for example. The generation unit 112 further adds the generated trend information to the generated music playback map Mp. Since the trend information about the music pieces is added to the music playback map Mp, the changes in the popularity of the music pieces can be grasped.

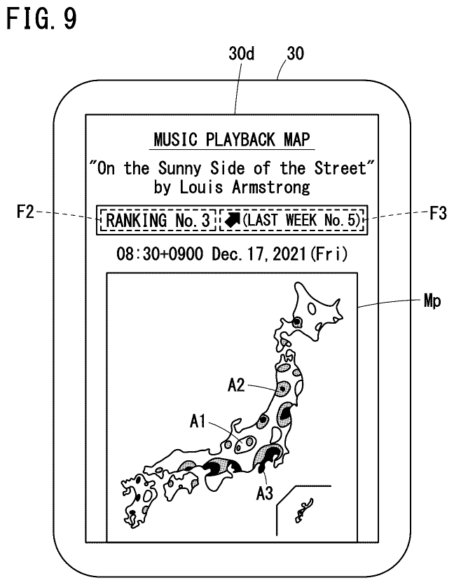

FIG. 9 is a diagram showing the display example where ranking information F2 and the trend information F3 of music pieces are added to the music playback map Mp. The music playback map Mp indicating at which location in a specific region a specific music piece is being played at a specific time is displayed on the display unit 30d of the map display device 30, as in FIG. 2A. Furthermore, in addition to the music playback map Mp, the ranking information F2 and the trend information F3 of the music piece are displayed.

In the example shown in FIG. 9, the ranking information F2 and the trend information F3 of the music piece are displayed in addition to the music playback map Mp indicating the locations where the music piece “On the Sunny Side of the Street” by the musician Louis Armstrong is played at 8:30 local time on Dec. 17, 2021 in Japan. As the ranking information F2, it is displayed that the ranking of the play count of the music piece is No. 3 in Japan. As the trend information F3, it is displayed that the ranking of the play count of the music piece is in an ascending trend from No. 5 last week.

In the example shown in FIG. 9, the ranking information F2 and the trend information F3 in Japan are displayed but the present disclosure is not limited to this. For example, ranking information F2 and trend information F3 in a region specified by a viewer of the music playback map Mp may be displayed.

### Modified Example 5

In the above-described embodiment, the music playback device 74 is provided in the vehicle 50 but the present disclosure is not limited to this. In modified example 5, the music playback device 74 is constituted by a portable terminal. FIG. 10 is a diagram illustrating a map generation system 10. In the example shown in FIG. 10, the location detection device 70, the communication device 72, and the music playback device 74 in the above-described embodiment are constituted by the portable terminal 150. That is, the music information, the location information, and the time information are supplied to the map generation device 20 by the portable terminal 150 via the communication network 40.

The processes performed by the map generation device 20 and the map display device 30 are similar to those of the above-described embodiment. Therefore, according to modified example 5, it is possible to grasp which music piece is being played by the portable terminal 150 at which location.

With respect to the above-mentioned embodiments and modified examples, the following supplementary notes are further disclosed.

### Supplementary Note 1

A map generation device (20) of the present disclosure includes an acquisition unit (110) configured to acquire music information about a music piece played by a music playback device (74) and location information indicating a location where the music piece is played by the music playback device, and a generating unit (112) configured to generate a music playback map (Mp) based on the location information and the music information acquired by the acquisition unit. Such a configuration can generate information that makes it possible to identify which music piece is being played at which location. That is, according to such a configuration, information about music pieces can be provided in a better manner.

### Supplementary Note 2

Regarding the map generation device according to Supplementary note 1, the acquisition unit may further acquire time information indicating a time instant at which the music piece is played by the music playback device, and the generating unit may generate the music playback map based further on the time information acquired by the acquisition unit. According to such a configuration, information can be generated that makes it possible to grasp play counts of a music piece at a specific time.

### Supplementary Note 3

Regarding the map generation device according to Supplementary note 1, the music playback device may be provided in a vehicle (50). Such a configuration can generate information that makes it possible to identify which music piece is being played in the vehicle at which location.

### Supplementary Note 4

Regarding the map generation device according to Supplementary note 1, the music playback device may be constituted by a portable terminal (150). Such a configuration can generate information that makes it possible to identify which music piece is being played at which location by a portable terminal.

### Supplementary Note 5

Regarding the map generation device according to any one of Supplementary notes 1 to 4, the generating unit may generate the music playback map for each music piece. According to such a configuration, information can be generated that makes it possible to grasp a play count of a specific music piece.

### Supplementary Note 6

Regarding the map generation device according to Supplementary note 2, the generating unit may generate the music playback map at every time instant. According to such a configuration, information can be generated that makes it possible to grasp the temporal change in a play count of a music piece.

### Supplementary Note 7

Regarding the map generation device according to any one of Supplementary notes 1 to 4, the music information may include information indicating a genre of the music piece, and the generating unit may generate the music playback map for each genre. Such a configuration can generate information that makes it possible to identify which genre of music pieces is being played at which location.

### Supplementary Note 8

Regarding the map generation device according to any one of Supplementary notes 1 to 4, the generating unit may generate the music playback map colored according to a play count, which is the number of times the music piece is played. Such a configuration makes it easier to view the music playback map.

### Supplementary Note 9

Regarding the map generation device according to any one of Supplementary notes 1 to 4, the music information may include information indicating a keyword included in lyrics or a title of the music piece, and the generating unit may generate the music playback map according to the keyword. According to such a configuration, information can be generated that make it possible to grasp the play count of the music piece related to a specific keyword.

### Supplementary Note 10

Regarding the map generation device according to any one of Supplementary notes 1 to 4, the music information may include information indicating a genre of the music piece, and the generating unit may superimpose activity schedule information (F1) on the music playback map, the activity schedule information being related to an activity schedule of a musician associated with the genre. Such a configuration enhances the convenience of the music playback map.

### Supplementary Note 11

Regarding the map generation device according to any one of Supplementary notes 1 to 4, the generating unit may superimpose activity schedule information on the music playback map, the activity schedule information being related to an activity schedule of a musician of the music piece. Such a configuration enhances the convenience of the music playback map.

### Supplementary Note 12

Regarding the map generation device according to any one of Supplementary notes 1 to 4, the generating unit may add ranking information (F2) to the music playback map, the ranking information indicating a ranking of a play count of the music piece at each location. With such a configuration, information can be generated that makes it possible to more clearly grasp the popularity of a music piece.

### Supplementary Note 13

Regarding the map generation device according to any one of Supplementary notes 1 to 4, the generating unit may add trend information (F3) associated with the music piece at each location to the music playback map. With such a configuration, information can be generated that makes it possible to grasp the change in the popularity of a music piece.

### Supplementary Note 14

A map generation system (10) of the present disclosure includes a map generation device and a map display device (30), comprising: an acquisition unit configured to acquire music information about a music piece played by a music playback device and location information indicating a location where the music piece is played by the music playback device; a generation unit configured to generate a music playback map based on the music information and the location information acquired by the acquisition unit; and a display unit (30d) configured to display the music playback map generated by the generation unit. Such a configuration can generate information that makes it possible to identify which music piece is being played at which location. That is, according to such a configuration, information about music pieces can be provided in a better manner.

### Supplementary Note 15

A map generation method of the present disclosure includes an acquisition step of acquiring music information about a music piece played by a music playback device and location information indicating a location where the music piece is played by the music playback device, and a generation step of generating a music playback map based on the music information and the location information acquired in the acquisition step. Such a configuration can generate information that makes it possible to identify which music piece is being played at which location. That is, according to such a configuration, information about music pieces can be provided in a better manner.

### Supplementary Note 16

A program of the present disclosure is a program for causing a computer to execute the map generation method according to Supplementary note 15. Such a configuration can generate information that makes it possible to identify which music piece is being played at which location. That is, according to such a configuration, information about music pieces can be provided in a better manner.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A map generation device comprising one or more processors executing computer-executable instructions stored in memory,
wherein the one or more processors execute the computer-executable instructions to cause the map generation device to:
acquire music information about a music piece played by a music playback device and location information indicating a location where the music piece is played by the music playback device; and
generate a music playback map based on the music information and the location information.

2. The map generation device according to claim 1, wherein
the one or more processors cause the map generation device to:
further acquire time information indicating a time instant at which the music piece is played by the music playback device; and
generate the music playback map based further on the time information.

3. The map generation device according to claim 1, wherein
the music playback device is provided in a vehicle.

4. The map generation device according to claim 1, wherein
the music playback device is constituted by a portable terminal.

5. The map generation device according to claim 1, wherein
the one or more processors cause the map generation device to generate the music playback map for each music piece.

6. The map generation device according to claim 2, wherein
the one or more processors cause the map generation device to generate the music playback map at every time instant.

7. The map generation device according to claim 1, wherein
the music information includes information indicating a genre of the music piece, and
the one or more processors cause the map generation device to generate the music playback map for each genre.

8. The map generation device according to claim 1, wherein
the one or more processors cause the map generation device to generate the music playback map colored according to a play count, which is the number of times the music piece is played.

9. The map generation device according to claim 1, wherein
the music information includes information indicating a keyword included in lyrics or a title of the music piece, and
the one or more processors cause the map generation device to generate the music playback map according to the keyword.

10. The map generation device according to claim 1, wherein
the music information includes information indicating a genre of the music piece, and
the one or more processors cause the map generation device to superimpose activity schedule information on the music playback map, the activity schedule information being related to an activity schedule of a musician associated with the genre.

11. The map generation device according to claim 1, wherein
the one or more processors cause the map generation device to superimpose activity schedule information on the music playback map, the activity schedule information being related to an activity schedule of a musician of the music piece.

12. The map generation device according to claim 1, wherein
the one or more processors cause the map generation device to add ranking information to the music playback map, the ranking information indicating a ranking of a play count of the music piece at each location.

13. The map generation device according to claim 1, wherein
the one or more processors cause the map generation device to add trend information associated with the music piece at each location to the music playback map.

14. A map generation system including a map generation device and a map display device and comprising one or more processors that execute computer-executable instructions stored in memory, wherein
the one or more processors execute the computer-executable instructions to cause the map generation system to:
acquire music information about a music piece played by a music playback device and location information indicating a location where the music piece is played by the music playback device;
generate a music playback map based on the music information and the location information; and
display the generated music playback map.

15. A map generation method comprising:
acquiring music information about a music piece played by a music playback device and location information indicating a location where the music piece is played by the music playback device; and
generating a music playback map based on the music information and the location information acquired in the acquiring.

16. A computer-readable non-transitory storage medium storing a program for causing a computer to execute the map generation method according to claim 15.
